(19) United States
(12) Patent Application Publication
(10) Pub. No.: US 2006/0221090 A1
(43) Pub. Date: Oct. 5, 2006

(54) Image processing apparatus, method, and program

(76) Inventors: Hidenori Takeshima, Ebina-shi (JP); Takashi Ida, Kawasaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/374,981

(22) Filed: Mar. 15, 2006

(30) Foreign Application Priority Data
Mar. 18, 2005 (JP) 2005-079584

(51) Int. Cl. G09G 5/00

(52) U.S. Cl. 345/582

(57) ABSTRACT

Image processing method includes acquiring image including object and background, acquiring initial region including object region containing object and background region containing background, setting target region including initial region in image, setting local region containing pixel of interest, calculating local object reliability indicating a degree that pixel of interest seems to belong to object region and local background reliability indicating degree that pixel of interest seems to belong to background region by using information of luminance or color of local object region and information of luminance or color of local background region, respectively, local object region including object region and local region and local background region including background region and local region, deciding that pixel of interest belongs to one of object region and background region, based on local object reliability and local background reliability, and outputting region information representing one of object region and background region.

### CROSS-REFERENCE TO RELATED APPLICATIONS

This application is based upon and claims the benefit of priority from prior Japanese Patent Application No. 2005-079584, filed Mar. 18, 2005, the entire contents of which are incorporated herein by reference.

### BACKGROUND OF THE INVENTION

1. Field of the Invention

The present invention relates to an image processing apparatus, method, and program which are associated with contour fitting for obtaining an accurate object region of a thin linear object (e.g., a character, a needle, or the tip of Tokyo Tower) when part of the object region is provided (or estimated).

2. Description of the Related Art

As a conventional technique, a technique of obtaining a telop (characters in an image) region in a video is available (see, for example,

Jpn. Pat. Appln. KOKAI Publication No. 2000-182053). A video contains, for example, one thin linear object. According to contour fitting used in the method disclosed in this reference, the luminance (or color; assume hereinafter that a luminance contains a color) distribution of an object region is estimated with respect to an entire target region, and the object region is calculated by determining whether each pixel belongs to the luminance distribution.

When a target region having a partial background mingled in a telop region is input, regions with colors other than white are regarded as background regions and removed. The Gaussian distribution parameter (average and variance) for approximating luminance distribution of the object region is estimated, and a threshold of luminance for the object is determined from the parameter. A white region which can be reliably regarded as an object region is set as a seed. Subsequently, region growing algorithm with respect to neighboring pixels of the seed is repeated by using the above threshold until there is no target pixel, thereby outputting the object region.

However, since the technique described in “Description of the Related Art” is based on the assumption that an entire target region can be represented by one luminance distribution, if an object region in a target region includes a portion having the same luminance as that of a background region, the portion is mistaken for a background region.

### BRIEF SUMMARY OF THE INVENTION

In accordance with a first aspect of the invention, there is provided an image processing method comprising: acquiring an image including an object and a background; acquiring an initial region including an object region containing the object and a background region containing the background; setting a target region including the initial region in the image; setting a local region containing a pixel of interest and included in the target region; calculating local object reliability indicating a degree that the pixel of interest seems to belong to the object region and local background reliability indicating a degree that the pixel of interest seems to belong to the background region by using information of a luminance or color of a local object region and information of a luminance or color of a local background region, respectively, the local object region including the object region and the local region and the local background region including the background region and the local region; deciding that the pixel of interest belongs to one of the object region and the background region, based on the local object reliability and the local background reliability; and outputting region information representing the one of the object region and the background region which is decided by the deciding.

In accordance with a second aspect of the invention, there is provided an image processing method comprising: acquiring an image; obtaining a label image having a same size as that of the acquired image; setting a target region in the acquired image; setting a local region containing a pixel of interest and included in the target region; calculating, for each local label value, reliability indicating a degree that a pixel of interest seems to belong to a label value by using information of a luminance or color of a local label value region, the local label value region having the label value and included in the local region; deciding, based on the reliability for each local label value, a label value to which the pixel of interest belongs, and applying, to the target region, the deciding the label value; and outputting a label image obtained by the deciding the label value.

In accordance with a third aspect of the invention, there is provided an image processing apparatus comprising: an acquiring unit configured to acquire an image including an object and a background, and an initial region including an object region containing the object and a background region containing the background; a setting unit configured to set a target region including the initial region in the image, and a local region containing a pixel of interest and included in the target region; a calculating unit configured to calculate local object reliability indicating a degree that the pixel of interest seems to belong to the object region and local background reliability indicating a degree that the pixel of interest seems to belong to the background region by using information of a luminance or color of a local object region and information of a luminance or color of a local background region, respectively, the local object region including the object region and the local region and the local background region including the background region and the local region; a deciding unit configured to decide that the pixel of interest belongs to one of the object region and the background region, based on the local object reliability and the local background reliability; and an outputting unit configured to output region information representing the one of the object region and the background region which is decided by the deciding unit.

In accordance with a fourth aspect of the invention, there is provided an image processing apparatus comprising: an acquiring unit configured to acquire an image; an obtaining unit configured to obtain a label image having a same size as that of the acquired image; a setting unit configured to set a target region in the acquired image and a local region containing a pixel of interest and included in the target region; a calculating unit configured to calculate, for each local label value, reliability indicating a degree that a pixel of interest seems to belong to a label value by using information of a luminance or color of a local label value region, the local label value region having the label value and included in the local region; a deciding unit configured to decide, based on the reliability for each local label value, a label value to which the pixel of interest belongs; and an outputting unit configured to output a label image obtained by the deciding unit.

In accordance with a fifth aspect of the invention, there is provided an image processing program stored in a computer readable medium comprising: means for instructing a computer to acquire an image including an object and a background and an initial region including an object region containing the object and a background region containing the background; means for instructing a computer to set a target region including the initial region in the image, and a local region containing a pixel of interest and included in the target region; means for instructing a computer to calculate local object reliability indicating a degree that the pixel of interest seems to belong to the object region and local background reliability indicating a degree that the pixel of interest seems to belong to the background region by using information of a luminance or color of a local object region and information of a luminance or color of a local background region, respectively, the local object region including the object region and the local region and the local background region including the background region and the local region; means for instructing a computer to decide that the pixel of interest belongs to one of the object region and the background region, based on the local object reliability and the local background reliability; and means for instructing a computer to output region information representing the one of the object region and the background region which is decided by the deciding means.

In accordance with a sixth aspect of the invention, there is provided an image processing program stored in a computer readable medium comprising: means for instructing a computer to acquire an image; means for instructing a computer to obtain a label image having a same size as that of the acquired image; means for instructing a computer to set a target region in the acquired image and a local region containing a pixel of interest and included in the target region; means for instructing a computer to calculate, for each local label value, reliability indicating a degree that a pixel of interest seems to belong to a label value by using information of a luminance or color of a local label value region, the local label value region having the label value and included in the local region; means for instructing a computer to decide, based on the reliability for each local label value, a label value to which the pixel of interest belongs; and means for instructing a computer to output a label image obtained by the deciding means.

### BRIEF DESCRIPTION OF THE SEVERAL VIEWS OF THE DRAWING

FIG. 1 is a block diagram showing an image processing apparatus according to the first embodiment of the present invention;

FIG. 2 is a flowchart showing the operation of the image processing apparatus in FIG. 1;

FIG. 3 is a view showing an example of a state wherein step S202 in FIG. 2 is started;

FIG. 4 is a view showing a region distribution in a region near a pixel of interest in FIG. 3;

FIG. 5 is a graph showing the luminance histograms of an object region in an alpha mask and a background region in the alpha mask in FIG. 4;

FIG. 6 is a graph showing the luminance of a pixel of interest in the luminance histograms in FIG. 5;

FIG. 7 is a block diagram showing an image processing apparatus according to the second embodiment of the present invention;

FIG. 8 is a flowchart showing the operation of the image processing apparatus in FIG. 7;

FIG. 9 is a view showing an example of an input image in the case shown in FIG. 7;

FIG. 10 is a view showing an object region and a background region when an alpha mask is applied to the input image in FIG. 9;

FIG. 11 is a view showing a label image generated by performing segmentation for the image in FIG. 9;

FIG. 12 is a graph showing occurrence frequencies at label 1 and label 2 in FIG. 11;

FIG. 13 is a view showing mask values, luminance values, and weight values for the respective label values in FIG. 11;

FIG. 14 is a graph showing an object likelihood and background likelihood which depend on mask values, label values, and luminances;

FIG. 15 is a view showing an example of how segmentation is effective;

FIG. 16 is a view showing an example of the comparison between simple histograms in FIG. 15 and histograms weighted in accordance with a segmentation result;

FIG. 17 is a view showing an example of how segmentation is performed for the image shown in FIG. 15; and

FIG. 18 is a view showing an example of a hash table.

### DETAILED DESCRIPTION OF THE INVENTION

An image processing apparatus, method, and program according to an embodiment of the present invention will be described in detail below with reference to the views of the accompanying drawing.

<Object>

It is an object of each embodiment of the present invention to accurately obtain an object region (e.g., a human figure) in an image. Inputs to each embodiment of the present invention are an image and an inaccurate, rough object region (an object region in an alpha mask) as an initial region. An object region in an alpha mask may include either or both of an object region in which a background region is mingled or a background region in which an object region is mingled. An output in each embodiment of the present invention is an accurate object region. Portions of an image which do not belong to object regions will be referred to as background regions. A target image includes, for example, an image in which visible light is converted into a numerical value by grayscale, RGB, YUV, HSV, or L*a*b on a pixel basis. However, each embodiment of the present invention is not limited to this. For example, such an image includes an image in which a depth value obtained by infrared light, ultraviolet light, an MRI measurement value, or a range finder is converted into a numerical value on a pixel basis.

The image processing technique of each embodiment of the present invention can equally handle grayscale and color images in which value of each pixel has multiple components. In this case, therefore, both a value expressed by one-dimensional grayscale and a value expressed by a multi-dimensional space such as RGB will be called luminances. As an example of an expression method for an object region, a binary image method is available. In the binary method a background region and an object region are respectively expressed by 0 and 1 for each pixel. This expression method is not limited to setting values of background region to 0 and values of object region to 1, and values of background and object region may be set to 1 and 0, respectively. These values are not limited to 0 and 1, and may be other values, e.g., 0 and 255. Such a binary image is called an alpha mask. The value of the alpha mask is called a mask value. In many cases, the present invention is directed to an alpha mask. However, an image expressed by another form can be used if it is converted into an alpha mask. Consider an image provided in the form of a 256 grayscale image with a background region and an object region being expressed by 0 and 255, respectively. In this case, this image may be converted into an alpha mask by setting a value less than 128 to 0, and a value equal to or more than 128 to 1, and the present invention may be applied to the converted image. An image or object region expression method to be used is not limited to this. The following embodiments are directed to still images unless otherwise described. However, the embodiments can be applied to even a space-time image obtained by time-serially arranging still images as long as an alpha mask corresponding to the time-space image is available. Likewise, if an N-dimensional (N: the number of dimensions) image and an N-dimensional alpha mask are provided, the technique of each embodiment of the present invention can be used.

In order to achieve this object, in each embodiment of the present invention, a luminance distribution on a periphery of each pixel is obtained, and the reliability at which the pixel is an object region and the reliability at which the pixel is a background region are calculated, thereby deciding that the pixel belongs to the region with higher reliability.

The image processing apparatus, method, and program according to each embodiment of the present invention can properly obtain an object region even if portions with the same luminance exist in an object region and background region in a target region.

### First Embodiment

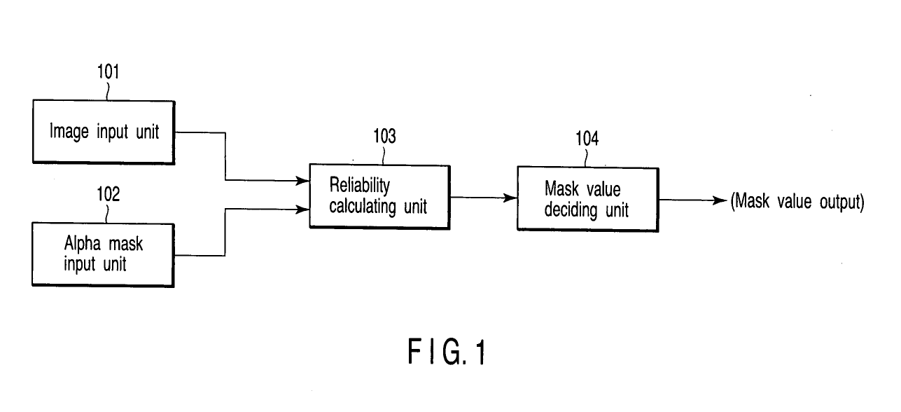

An image processing apparatus according the first embodiment will be described next with reference to FIG. 1.

As shown in FIG. 1, the image processing apparatus of this embodiment comprises an image input unit 101, alpha mask input unit 102, reliability calculating unit 103, and mask value deciding unit 104.

The image input unit 101 acquires an image subjected to image processing.

The alpha mask input unit 102 acquires an object region in an alpha mask and a background region in the alpha mask.

The reliability calculating unit 103 sets a pixel of interest in a target region, and calculates the reliability indicating a degree that the pixel of interest seems to belongs to the object region and the reliability indicating a degree that the pixel of interest seems to belong to the background region by using the luminance of the object region in the alpha mask and the luminance of the background region in the alpha mask in a range set for each pixel of interest.

The mask value deciding unit 104 compares the reliability at which the pixel of interest is an object and the reliability at which the pixel of interest is a background which are obtained by the reliability calculating unit 103, and determines whether the pixel of interest is an object or background, thereby deciding the mask value of the pixel of interest.

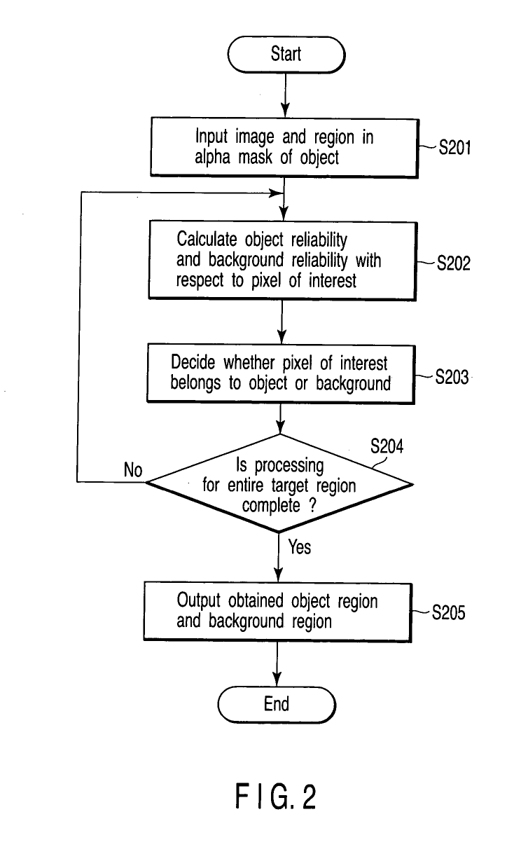

The operation of the image processing apparatus shown in FIG. 1 will be described next with reference to FIG. 2. FIG. 2 shows how the image processing apparatus in FIG. 1 decides the object likelihood and background likelihood of the luminance for each pixel on the basis of the luminance distribution and color distribution while shifting the pixel of interest.

The image input unit 101 acquires an image as an input (step S201). The alpha mask input unit 102 acquires an object region in an alpha mask (step S201). The alpha mask input unit 102 ensures a buffer for storing an output object region, and copies the object region in the alpha mask with respect to a portion other than the target region which includes the image to be scanned. The alpha mask input unit 102 acquires set region information of a pre-determined target region. This target region is, for example, the entire interior of the image. The pre-determined target region will be described later.

The alpha mask input unit 102 may calculate positions of the boundary pixels between the object region in the alpha mask and the background region in the alpha mask, and generate a region centering on the positions of the boundary pixels and having a width corresponding to the pre-determined number of pixels, thereby setting the region as a target region. Alternatively, a region containing the positions of the boundary pixels and having the width corresponding to the pre-determined number of pixels may be set as a target region regardless of whether the region centers on the positions of the boundary pixels.

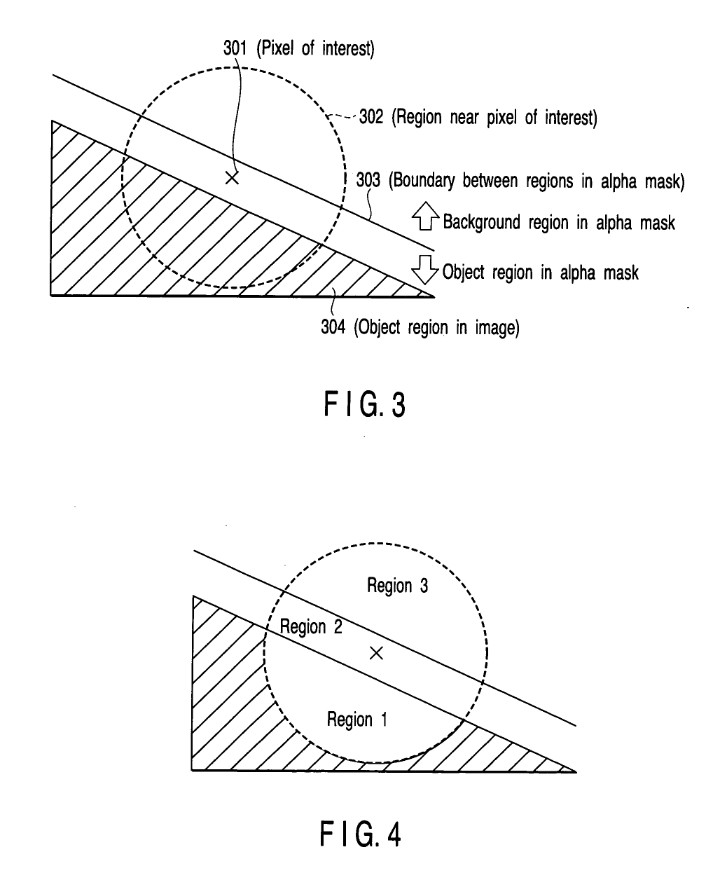

The reliability calculating unit 103 sets the pixel of interest as a start pixel in the target region acquired in step S201. The reliability calculating unit 103 calculates the reliability indicating a degree that the pixel of interest seems to belongs to the object region (to be referred to as object reliability) and the reliability indicating a degree that the pixel of interest seems to belong to the background region (to be referred to as background reliability) by using the luminance of the object in the alpha mask and the luminance of the background in the alpha mask in the pre-determined range which is determined for each pixel of interest (step S202). In this case, this “pre-determined range” is, for example, the range enclosed by the circle shown in FIG. 3 afterward, which will be described in detail later.

The mask value deciding unit 104 compares the two reliability items, i.e., the object reliability and the background reliability, in the pixel of interest, assigns the pixel of interest the region corresponding to the higher reliability, and writes the corresponding information in the buffer which stores output object regions (step S203). That is, the mask value deciding unit 104 decides whether the pixel of interest is an object or background.

The mask value deciding unit 104 determines whether all the pixels in the target region have already been processed. If not all the pixels have been processed, the pixel of interest is shifted to the next pixel, and the flow returns to step S202. If all the pixels have been processed, the flow advances to step S205 (step S204). In step S205, the mask value deciding unit 104 outputs the obtained object region and background region. That is, the mask value deciding unit 104 outputs the output object regions recorded in the buffer.

With this technique, each pixel of interest is regarded as an object region if a surrounding region having a similar luminance is an object region. This also applies to a background region. The reason for this will be described with reference to the case shown in FIGS. 3, 4, 5, and 6.

FIG. 3 shows an example of a state wherein step S202 is started. A pixel of interest 301 is contained in an object region in an alpha mask, and hence its mask value is 1. However, this pixel is not contained in an object 304 in the image. Therefore, a request from the user is to automatically set the mask value of this pixel to 0. Consider a circle centering on the pixel of interest and having a pre-determined radius as a pre-determined range in step S202. In this case, if the pixel 301 is a pixel of interest, a region 302 near the pixel of interest is a range used for the calculation of reliability.

As shown in FIG. 4, in the region 302 near the pixel of interest, the object region in the alpha mask contains an object (region 1 in FIG. 4) in the image and a background (region 2 in FIG. 4) in the image, and the background region in the alpha mask contains a background (region 3 in FIG. 4) in the image.

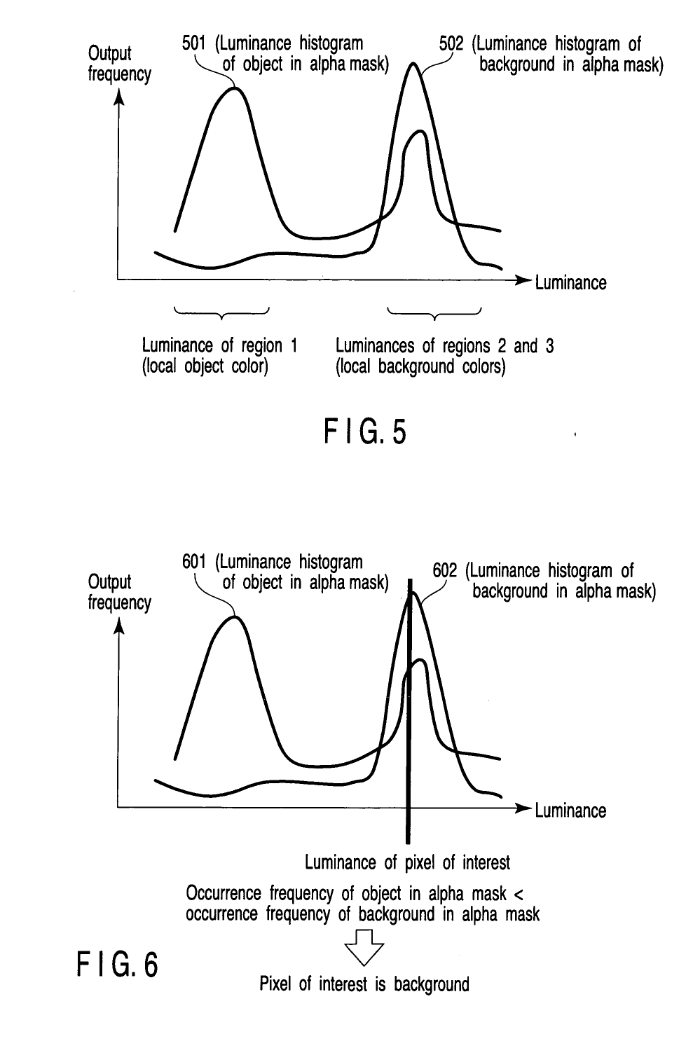

Consider the occurrence frequency of each luminance as an example of reliability. The object region in the alpha mask contains regions 1 and 2 in FIG. 4. Referring to FIG. 5, reference numeral 501 denotes an occurrence frequency histogram corresponding to the luminances of these regions; and 502, a histogram corresponding to the background region in the alpha mask. In this case, as shown in FIG. 6, when the occurrence frequency of an object region in the alpha mask is compared with the occurrence frequency of a background region in the alpha mask at the luminance of the region 302 near the pixel of interest, the occurrence frequency of the object region in the alpha mask is higher in many cases. This is because, in many cases, the occurrence frequency at the luminance of a background (region 2 in FIG. 4) mingled in the object region in the alpha mask does not exceed the occurrence frequency of the luminance of a background contained in the background region in the alpha mask. According to the case shown in FIG. 6, the pixel of interest is determined as a background region. In other words, the mask value of this pixel of interest is determined as 0 instead of 1. In this case, an occurrence frequency corresponds to the area of a region having the same luminance as that of the region 302 near the pixel of interest in each of the object region and the background region.

Since some pixels in region 2 in FIG. 4 are made to change from 1 to 0 by applying steps S201 to S205, i.e., by applying steps S202 to S204 while shifting the pixel of interest, the object region in the alpha mask approaches the object region in the image which is expected by the user. Whether a desired object region in the image can be obtained by one application of steps S201 to S205 depends on reliability and a target range (the region 302 near the pixel of interest) for each pixel of interest. Assume that a desired object region cannot be obtained by first processing. Even in this case, in the second and subsequent processing, the object region can be made to approach the desired object region by repeatedly applying steps S202 to S204 until a pre-determined condition is satisfied, while using the result in step S204, which is the immediately preceding step, as an input to step S202. The pre-determined condition in the repetitive application may be that application is repeated by a predetermined number of times. Alternatively, the number of pixels whose mask values have changed before and after the application of steps S202 to S204 may be counted. When the number of pixels becomes 0 or does not decrease, the application of the steps may be stopped. Alternatively, when the number of times of application reaches a predetermined number of times or the number of pixels whose mask values have changed satisfies the above condition, the application of the steps may be stopped.

When such a simple occurrence frequency histogram is to be used, the same occurrence frequency of luminance as that of the pixel of interest allows comparison between reliability items. In executing this technique, therefore, even if a complete histogram in a target range is not calculated, it suffices to count the number of pixels having the same luminance as that of the pixel of interest in an object region in an alpha mask and that in a background region in the alpha mask and compare them.

<Pre-Determined Range>

As a pre-determined range which is determined for each pixel of interest in step S202, for example, a circular range centering on the pixel of interest and having a pre-determined radius r or a rectangular range having a pre-determined shape so as to have a pixel of interest at the intersection of diagonal lines may be set. However, the intersection of the diagonal lines need not be a pixel of interest, and the shape of the range to be set is not limited to a rectangle. Instead of a rectangle, for example, a square, rhombus, parallelogram, regular hexagon, or regular octagon may be used. Such a range (a circle with a radius r or a square) which is so determined as to center on a pixel of interest will be referred to as a fixed shape Z hereinafter. Note that an entire frame may be subjected to segmentation (to be described later) to generate a label image, and a region having the same label value as that of a pixel of interest may be set as its range for each pixel of interest. Processing is performed for each pixel of interest in the embodiments of the present invention. If, however, only a portion having the same label value as that of the pixel of interest is set as a range in this manner, since a single local region is set for each label value, there is no need to calculate a histogram for each pixel of interest. This increases the processing speed. In compensation for this, if segmentation fails, the resultant position becomes inaccurate. A technique of obtaining a better result by using a segmentation result will be described later.

The pre-determined target region in step S201 may be an entire frame or may be limited to part of a frame (for example, only a desired portion designated by the user). Alternatively, for example, the fixed shape Z centering on a pixel of interest can be determined as a range as follows. First of all, a mark buffer A and a mark buffer B each having the same size as that of an image and containing only values of 0s are created. In each mark buffer, 0 indicates that a pixel is not marked, and 1 indicates that a pixel is marked. All the pixels in the alpha mask are scanned to search for a pixel whose neighboring pixels are 0 and 1, and every pixel whose neighboring pixels are 0 and 1 are marked (i.e., is are set to the corresponding pixels in the mark buffer A). With respect to all the pixels on the mark buffer A which are set to is, all the fixed shapes Z centering on these points are marked on the mark buffer B. The obtained mark buffer B contains all the pixels whose mask values may change in the alpha mask. If a marked pixel on the mark buffer B is set as the pre-determined target region in step S201, the same result can be quickly obtained with respect to many input alpha masks without processing the entire frame.

<Reliability>

The reliability items obtained in step S202 represent the object likelihood and background likelihood of the pixel of interest in numerical values. The above occurrence frequency is an example of such an expression. If, however, the number of pixels in a range in which a histogram is to be calculated is small, such an expression may not always work as expected. One of the methods of solving this is to make a histogram coarse in the luminance direction. For example, a histogram is calculated such that luminance 0 to 255 is equally divided by 16 instead of 256. Another method of solving the problem is to apply a smoothing filter which expands in the luminance axis direction of the histogram (for the sake of convenience, the sum of values other than 1 as in this case, will also be called an occurrence frequency or histogram hereinafter).

As a simple smoothing filter, there is available a filter which adds 0.4 to the frequency of luminance 100, 0.2 to the frequencies of luminance 99 and luminance 101, and 0.1 to the frequencies of luminance 98 and luminance 102, instead of adding 1 to the frequency of luminance 100. Alternatively, a pre-determined normal distribution (e.g., a normal distribution with an average of 0 and a standard deviation of 10 in the luminance axis direction) may be applied to an obtained histogram in the luminance axis direction of the histogram. Using the smoothing filter in this manner makes it possible to properly calculate the mask value of a pixel of interest even with a small number of pixels. The above description has been made with reference to a one-dimensional histogram. If, however, the number of dimensions of color is large, the number of dimensions of a histogram may be increased. For example, three-dimensional histograms may be used for RGB and YUV, and four-dimensional histograms may be used for CMYK (cyan, magenta, yellow, and black). In addition, since the correlation between a pixel in a target range and a pixel of interest is expected to decrease as the distance (e.g., the L1 (Manhattan) distance or L2 (Euclidian) distance) from the target pixel increases, weighting the value added to the histogram in accordance with the distance from the target pixel makes it easier to select a proper mask value. More specifically, for example, a circle with a radius r from a target pixel is set as a target range, and the value added to the histogram at a pixel with a distance x from the target pixel is set to (r−x)/r (when the value added to the histogram becomes negative, it is set to 0) instead of addition of 1, as a value added to the histogram, to all the pixels as in the above case. Another example of the weighted value is that a value obtained by substituting a distance x from a target pixel into a pre-determined one-dimensional regular distribution function may be used as a weighted value. Note that a value (the occurrence frequency of luminance) normalized by dividing a histogram by the sum total of occurrence frequencies may be used as reliability. Furthermore, according to the above description, a case wherein an object is mistaken for a background and a case wherein a background is mistaken for an object are handled in the same manner. If, however, one type of errors is to be reduced at the cost of an increase in the other type of errors, a pre-determined threshold may be added to one of reliability.

### Second Embodiment

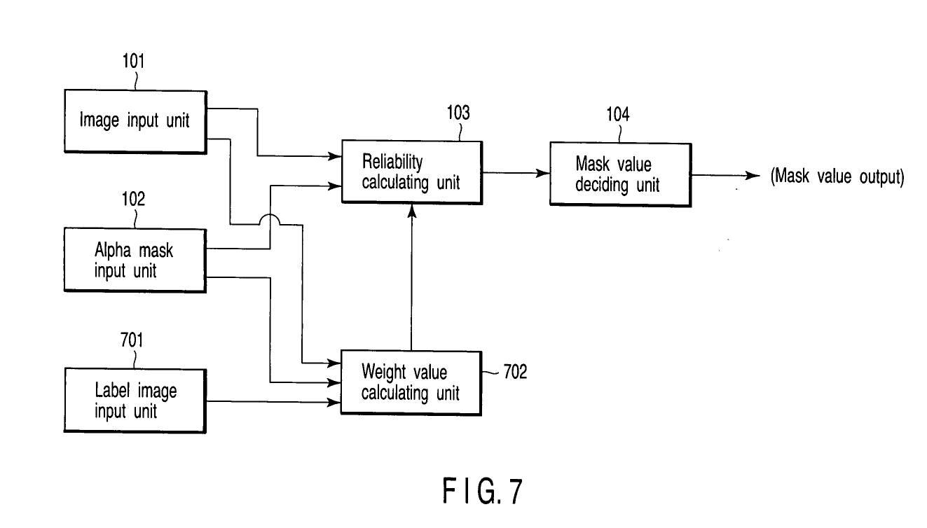

An image processing apparatus according to the second embodiment will be described with reference to FIG. 7.

The image processing apparatus according to this embodiment is obtained by adding a label image input unit 701 and a weight value calculating unit 702 to the image processing apparatus in FIG. 1. The remaining components of the apparatus are denoted by the same reference numerals as in FIG. 1, and a description thereof will be omitted.

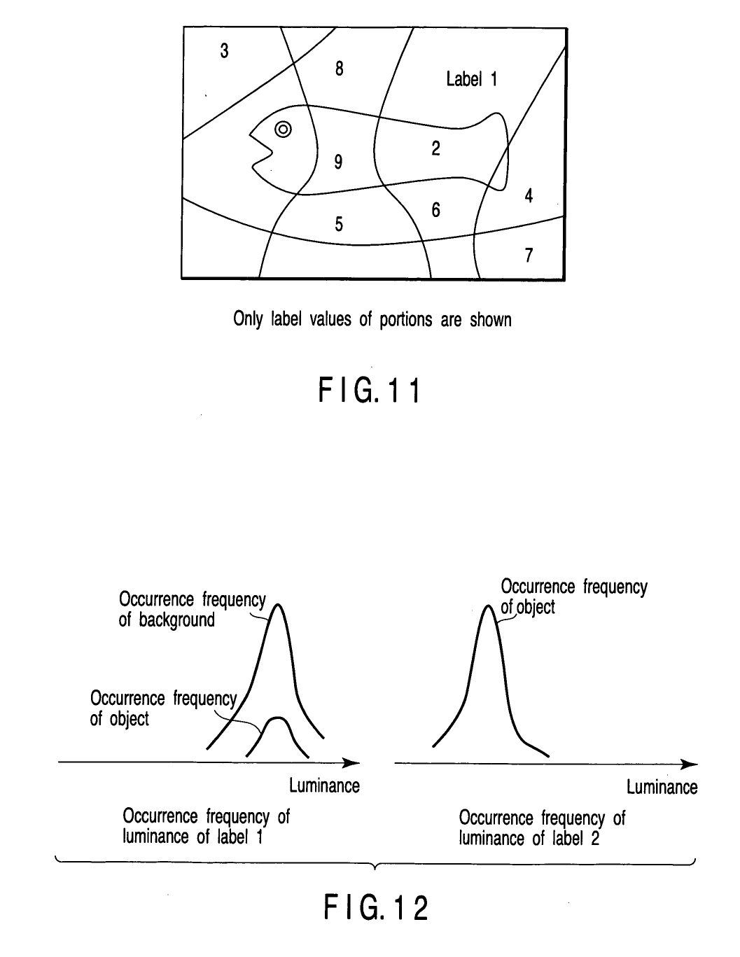

The label image input unit 701 acquires a label image like that shown in FIG. 11. The label image input unit 701 may automatically generate a label image by segmenting an input image into regions.

The weight value calculating unit 702 calculates weight values for an object region (a mask value of 1) in an alpha mask and a background region (a mask value of 0) in the alpha mask by using an image, regions in the alpha mask, and a label image for each label value of the label image and each pixel luminance or color value.

This embodiment exemplifies a technique of providing a label image as an input, in addition to an image and an alpha mask, which is provided as one of reliability items other than the reliability in the first embodiment, and using this input. A label image is a set of integers (e.g., FIG. 11) whose size and dimension are same as those of an image and is obtained by assigning one label value (integer value) to pixels belonging to a portion regarded as a single region in the image. As a technique of generating a label image, for example, Watersheds (IEEE Trans. Pattern Anal. Machine Intell. Vol. 13, No. 6, pp. 583-598, 1991) or segmentation in which Mean Shift (IEEE Trans. Pattern Anal. Machine Intell. Vol. 17, No. 8, pp. 790-799, August 1995) is applied to a color space can be used. Alternatively, a label image may be separately prepared.

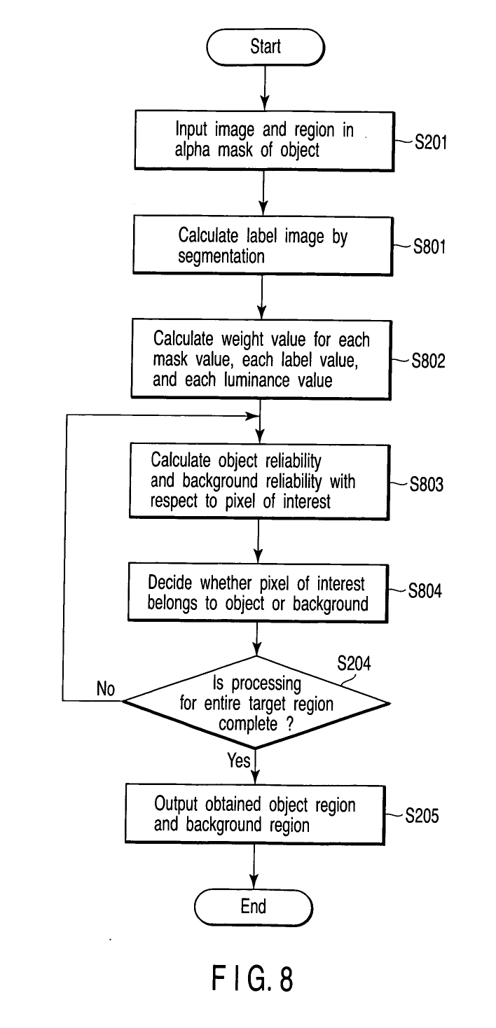

The operation of the image processing apparatus in FIG. 7 will be described with reference to FIG. 8. The same step numbers as in the flowchart of FIG. 2 denote the same steps in the flowchart of FIG. 8, and a description thereof will be omitted.

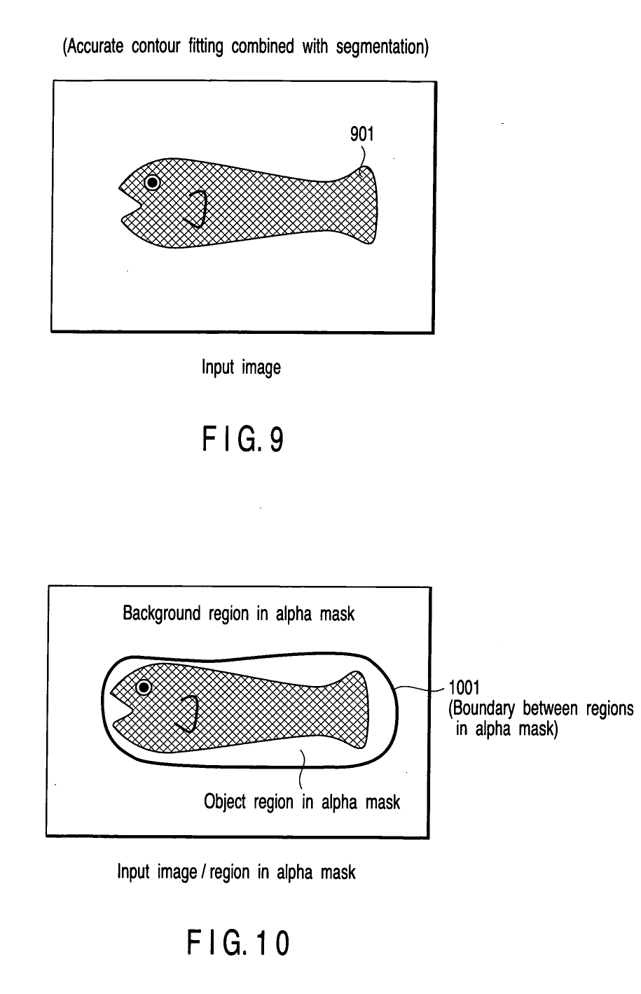

The following is a case wherein when the image in FIG. 9 and the object region in the alpha mask in FIG. 10 are provided, the object region in the image is obtained. Immediately after step S201 described above, segmentation is performed by using the image in FIG. 9 to automatically generate the label image in FIG. 11 (step S801). Subsequently, as shown in FIG. 12, occurrence frequency histograms (or smoothed histograms obtained by applying a smoothing filter to these histograms in the above manner) are created, for each region having the same label value, with respect to the object region in the alpha mask and the background region in the alpha mask, and the created histograms are normalized such that the sum total of the histograms of the object region and background region in the alpha mask becomes a predetermined value, e.g., 1 (step S802).

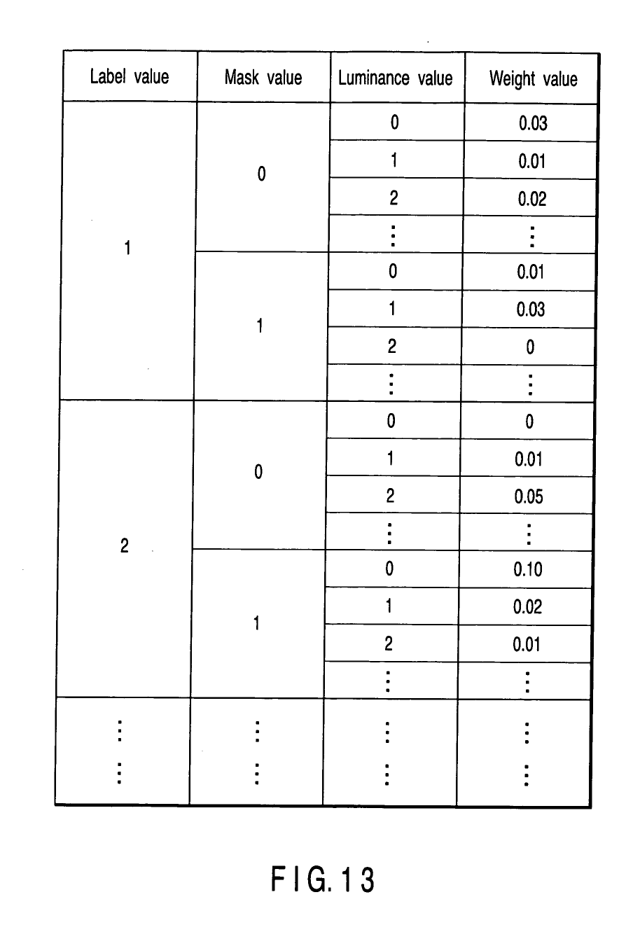

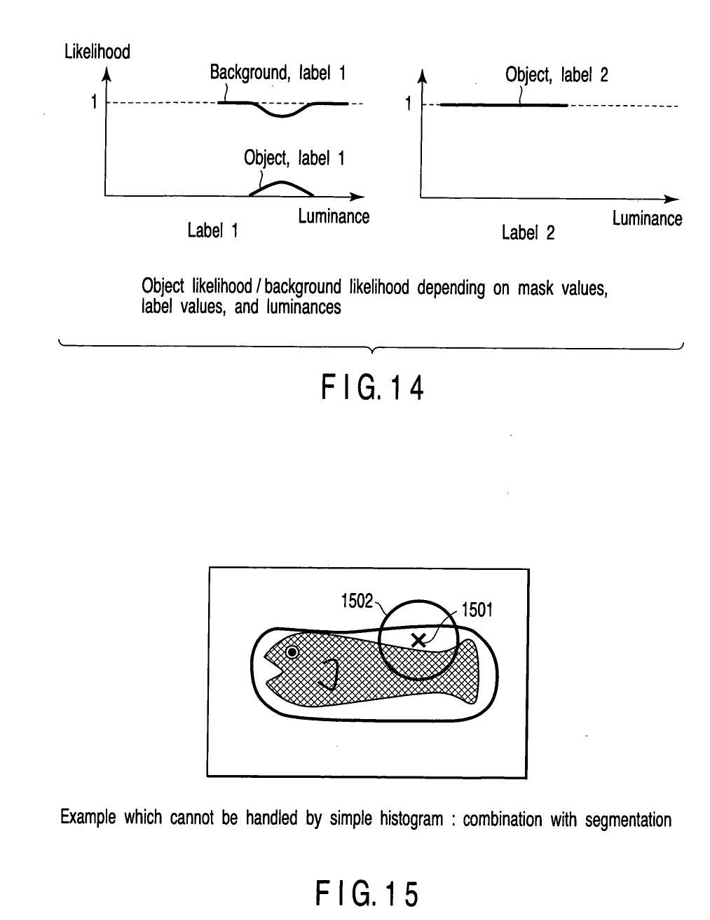

Note that normalization may be performed such that the total sum of histograms within each label value becomes a predetermined value, e.g., 1. Such an occurrence frequency histogram corresponds to a weight value. For example, FIG. 13 shows the obtained occurrence frequency histograms. When the object likelihood and background likelihood of each luminance are to be used, an object likelihood and a background likelihood of each luminance are calculated as shown in FIG. 14 for each luminance on the basis of the above histograms. Note that normalization may not be performed in such a manner that the total sum is set to a predetermined value, e.g., 1. An object likelihood is calculated for each luminance by using a value obtained by (object occurrence frequency value of luminance)/((object occurrence frequency value of luminance)+(background occurrence frequency value of luminance)). For a background likelihood, a value calculated in the same manner as described above is used. It suffices to perform the above processing only once before the loop after step S202.

A reliability calculating unit 103 then calculates histograms corresponding to a pixel of interest with respect to the object region and the background region by using an occurrence frequency histogram for each label value (step S803). A mask value deciding unit 104 decides a mask value by comparing these occurrence frequencies at the pixel of interest as reliability (step S804). The subsequent processing is the same as that in the flowchart of FIG. 2.

Note that each of histograms corresponding to a pixel of interest, the histograms being corresponding to the object region and the background region, is calculated by using values obtained by, for example, counting the numbers of pixels having each label value in a target range (or the numbers of pixels weighted in accordance with distances from the pixel of interest by the above technique), multiplying a histogram for each label value by the counted numbers of pixels, and adding multiplied histograms for label values. Alternatively, for each pixel in the target range, a histogram value of the pixel is acquired by using three values, i.e., the mask value, label value, and luminance value of the pixel, and histograms corresponding to the respective mask values (of both the object region and the background region) are calculated by adding these histogram values. Alternatively, for each pixel in the target range, histograms are calculated by using the above-mentioned object likelihood and background likelihood, which are acquired by using the three values (the mask value, label value, and luminance value of the pixel) as indices, for each luminance as weight values.

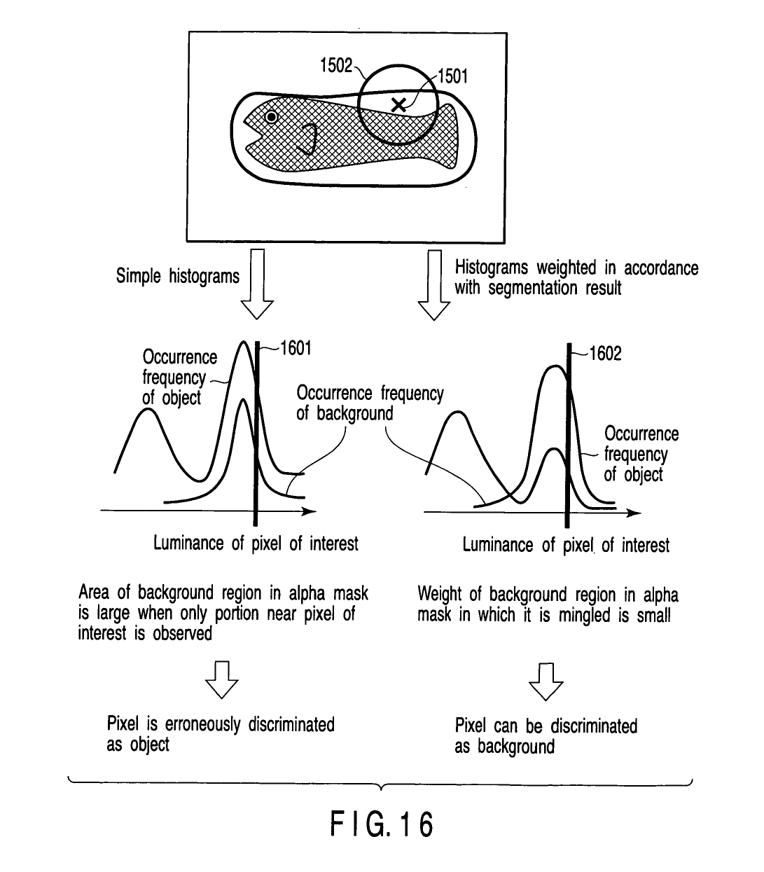

Assume that a target pixel 1501 in FIG. 15 is determined in a range 1502 in FIG. 15. In this case, according to a technique using no segmentation result, since the area of a background (a portion other than the fish image) contained in the object region in the alpha mask is larger than the area of a background contained in the background region in the alpha mask when only a portion near the pixel of interest is observed, the magnitude relationship between the frequency of the object region and that of the background region at the luminance of the pixel of interest indicates that the occurrence frequency of the object region is higher, as indicated by reference numeral 1601 in FIG. 16. As a consequence, it is determined that the pixel of interest exists in the object region.

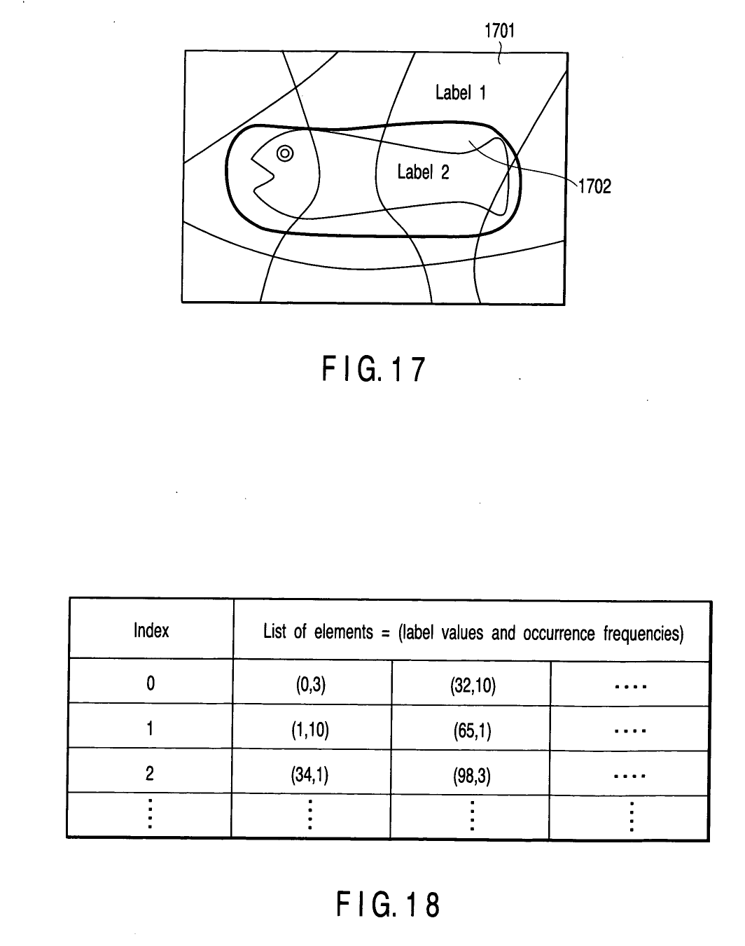

In the case that a segmentation result is used, as indicated by reference numerals 1701 and 1702 in FIG. 17, if an object region and background region within a label differ in area ratio for each luminance, a weight assigned to the occurrence frequency of the background region can be made higher than a weight assigned to the occurrence frequency of the object region. As a consequence, even if the occurrence frequency of the background region is lower than that of the object region at label 1, since a high weight is assigned to the occurrence frequency of the background region, the magnitude relationship indicates that the occurrence frequency value of the background region is larger, as indicated by reference numeral 1602 in FIG. 16. Therefore, it can be discriminated as expected by the user that the pixel of interest exists in the background region.

<<Magnitude Relationship Between Reliability Items>>

According to the above embodiment, the higher value of the reliability is assumed to be more reliable. However, it suffices to use an index indicating that the lower value of the reliability is assumed to be more reliable. In this case, for example, the value obtained by multiplying the above reliability by −1 may be used.

<Multilevel Label Image>

In the above embodiment, the mask value of each pixel in an input and an output is a binary value, i.e., it corresponds to an object region or a background region. This technique, however, can be used for contour fitting for images obtained by segmentation or the like (this technique will be referred to as image label contour fitting hereinafter) if the flowchart of FIG. 2 is extended for label images in which each pixel may belong to more than two regions by changing part of the flowchart.

In the label image input unit 701, segmentation is performed to the image for acquiring a label image (step S801) instead of performing step S201. The label image input unit 701 may input an image and a separately prepared label image instead of performing steps S201 and S801.

The reliability calculating unit 103 obtains reliability for each label value with respect to a pre-determined range determined for each pixel of interest (step S803). For example, the occurrence frequency of each label value is obtained. The mask value deciding unit 104 compares the reliability items for all the label values, and determines a value with the highest reliability as a label value to be assigned to the pixel of interest (step S804).

In this case, the same processing as that for binary values is performed except for these changes. One of the techniques of calculating an occurrence frequency for each label is to set occurrence frequencies for all the labels to 0 and add occurrence frequencies for each pixel in a local region in correspondence with a label. Another technique of calculating an occurrence frequency for each label is to prepare a list of pairs of empty label values and their occurrence frequencies, check whether there is any element corresponding to a label value, and add an occurrence frequency if there is an element corresponding to the label value or create a new element and add an occurrence frequency if there is no such element. In addition to these techniques, the following speeding up technique is available.

<High-Speed Algorithm for Multilevel Label Image>

The purpose and method of image label contour fitting are the same as those in the case of binary values. If, however, there are many kinds of labels, since an occurrence frequency is obtained for each label with respect to a pre-determined range determined for each pixel of interest, it requires much time for the step of searching for a value with the highest reliability. In this case, high-speed calculation can be realized by using the hash method (Haruhiko Okumura, “Algorithm Dictionary in C Language”, pp. 214-216, ISBN4-87408-414-1).

The following is a case wherein a storage area in a hash table in which pairs of label values and their occurrence frequencies like those shown in FIG. 18 can be recorded is used. For example, a function for calculating the remainder of 32 divided by a label value is set as a hash function, and the number of entries of the hash table is set to 32 (obviously, the hash function and the number of entries of the hash table to be used are not limited to them). The hash table is then set such that it has no element (initialization of the hash table). The following operations are performed for each pixel for which occurrence frequencies are added:

(1) obtaining an index in the hash table by the hash function;

(2) checking whether there is any element corresponding to the label value in the entry designated by the index; and

(3) adding an occurrence frequency if there is an element corresponding to the label value, or creating a new element and adding an occurrence frequency if there is no such element.

With this processing, an occurrence frequency is obtained for each label. Subsequently, the occurrence frequencies of all the elements in the hash table are compared to obtain a label value with the highest occurrence frequency. This can increase the calculation speed if the total number of labels is much larger than the number of hash elements. Although the case wherein an open hash technique is used has been described, a closed hash technique (a technique in which when the first element obtained by the hash function is in use, the next element position is obtained by using the hash function again) may be used. In the case of the closed hash technique, a hash function for calculating the remainder of 32 upon addition of 1 may be used as a hash function to be applied to the second and subsequent elements when the first element is in use.

<Parallel Computation>

In the embodiments of the present invention, independent calculation is performed for each pixel of interest. If, therefore, two or more calculation units can be used, calculation can be performed at a higher speed by allocating calculations for different pixels of interest to different calculation units.

<How to Provide Object Region in Alpha Mask>

One of the techniques for providing an object region in a binary alpha mask is a manual input operation using a mouse or pen tablet. Alternatively, a known technique of automatically obtaining an object region in an alpha mask can be used as an input technique in the embodiments of the present invention. Such techniques include, for example, the background difference method in which when time-series images are to be sequentially input, a background image photographed without any object is prepared, and if the difference value between a sequentially input image and the background image exceeds a threshold, the corresponding portion is regarded as an object, and the inter-frame difference method in which if the difference value between the image of a past frame and the image of the current frame exceeds a threshold, the corresponding portion is regarded as an object.

<Effects Compared with Other Techniques>

As compared with the prior art, the most characteristic feature of the technique of the embodiments of the present invention is that reliability items are calculated for the respective pixels and the respective mask values on the basis of different distributions. Calculating reliability items on the basis of them makes it possible to improve the performance by utilizing the nature of a natural image that the correlation between a given pixel and another pixel increases with a decrease in distance between the pixels. This correlation is not utilized in the prior art.

In addition, the embodiments of the present invention are based on the assumption that neither of a provided object region in an alpha mask nor a provided background region in the alpha mask is reliably correct. In contrast to this, although the conventional region growing algorithm is known and widely used, since the region growing algorithm is started from a reliably correct region, the method fails if either of the regions is reliably correct.

Furthermore, since the technique of the embodiments of the present invention makes no assumption about the shapes of an object region and background region, if the luminance distribution of an object region differs from that of a background region only in a portion around a pixel of interest, the mask value of the pixel of interest can be properly discriminated. According to Snakes (M. Kass et al, “Snakes-Active Contour Models”, International Journal of Computer Vision, vol. 1, No. 4, pp. 321-331, 1988), which is widely known as a technique for calculating an accurate object region from a provided object region in an alpha mask, since optimization is performed on the assumption of smooth contours, it is difficult to accurately obtain thin lines or acute corners.

According to the above embodiments, a luminance distribution around each pixel is obtained, and the reliability at which the pixel is an object region and the reliability at which the pixel is a background region are calculated. It is then determined that the pixel belongs to the region with the higher reliability. This makes it possible to properly obtain an object region even if portions with the same luminance exist in an object region and background region in a target region.

According to the image processing apparatus, method and, program of the embodiments of the present invention, even if portions with the same luminance exist in an object region and background region in a target region, an object region can be properly obtained.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing method comprising:
acquiring an image including an object and a background;
acquiring an initial region including an object region containing the object and a background region containing the background;
setting a target region including the initial region in the image;
setting a local region containing a pixel of interest and included in the target region;
calculating local object reliability indicating a degree that the pixel of interest seems to belong to the object region and local background reliability indicating a degree that the pixel of interest seems to belong to the background region by using information of a luminance or color of a local object region and information of a luminance or color of a local background region, respectively, the local object region including the object region and the local region and the local background region including the background region and the local region;
deciding that the pixel of interest belongs to one of the object region and the background region, based on the local object reliability and the local background reliability; and
outputting region information representing the one of the object region and the background region which is decided by the deciding.

2. The method according to claim 1, wherein setting the target region comprises setting the target region including all pixels in the image.

3. The method according to claim 1, wherein setting the target region comprises
calculating a plurality of positions of boundary pixels between the object region and the background region; and
setting in the image a region containing the boundary pixels and having a width corresponding to number of pixels as the target region.

4. The method according to claim 1, wherein a graphic pattern is set with reference to the pixel of interest, and an interior of the graphic pattern is set as the local region.

5. The method according to claim 1, wherein
an area of an interior of the local object region having a same luminance or color as that of the pixel of interest is used as the local object reliability,
an area of an interior of the local background region having the same luminance or color as that of the pixel of interest is used as the local background reliability, and
when it is decided whether the pixel of interest belongs to the object region or the background region, it is decided that the pixel of interest belongs to a region with higher reliability of the local object reliability and the local background reliability.

6. The method according to claim 1, further comprising:
obtaining a label image having a same size as that of the acquired image, and obtaining a plurality of label images; and
obtaining a weight value, for each of label values of the label images and each value of a luminance or color of each pixel, by using the acquired image, the initial region, and the label image with respect to the object region and the background region, to acquire a plurality of weight values, and
wherein the weight value is acquired for each pixel in the interior of the local object region from three values including a mask value, a label value, and a luminance or color of the pixel in the object region, and a sum total of the weight values is used as the local object reliability and the local background reliability, and
when it is decided whether the pixel of interest belongs to the object region or the background region, it is decided that the pixel of interest belongs to a region with higher reliability of the local object reliability and the local background reliability.

7. An image processing method comprising:
acquiring a first image;
acquiring a second image having a same size as that of the first image;
generating an initial region in which each of the first image and the second image is determined as an object region when a difference value between the first image and the second image falls outside a range, and is determined as a background region when the difference value falls within the range; and
inputting the first image and the initial region and applying, to the first image and the initial region, the image processing method defined in claim 1.

8. An image processing method comprising:
acquiring an image;
obtaining a label image having a same size as that of the acquired image;
setting a target region in the acquired image;
setting a local region containing a pixel of interest and included in the target region;
calculating, for each local label value, reliability indicating a degree that a pixel of interest seems to belong to a label value by using information of a luminance or color of a local label value region, the local label value region having the label value and included in the local region;
deciding, based on the reliability for each local label value, a label value to which the pixel of interest belongs, and applying, to the target region, the deciding the label value; and
outputting a label image obtained by the deciding the label value.

9. The method according to claim 8, wherein setting the target region comprises setting the target region including all pixels in the acquired image.

10. The method according to claim 8, wherein the setting the target region comprises
calculating a plurality of positions of boundary pixels each having a label value different from an adjacent label value in the label image, and
setting in the image a region containing the boundary pixels and having a width corresponding to number of pixels as the target region.

11. The method according to claim 8, wherein a graphic pattern is set with reference to the pixel of interest, and an interior of the graphic pattern is set as the local region.

12. The method according to claim 8, wherein
an area of an interior of the local label value region having a same luminance or color as that of the pixel of interest is used as the reliability for each local label value, and
when a label value to which the pixel of interest belongs is decided, it is decided that the pixel of interest belongs to a region with a label value having highest reliability of reliability items each decided for each local label value.

13. The method according to claim 12, wherein the area of the interior of the local label value region is calculated by
initializing a hash table holding hash elements as pairs of label values and occurrence frequencies, each of the hash elements failing to exist in the hash table,
calculating a hash element position at which the label value is held in the hash table,
increasing an occurrence-frequency value of the label value if the label value is held at the hash element position,
creating a hash element on which the label value and the occurrence-frequency value are recorded in the hash table if the label value fails to be held at the hash element position, and
applying the creating the hash element to all pixels in the local region with respect to the pixel of interest.

14. An image processing apparatus comprising:
an acquiring unit configured to acquire an image including an object and a background, and an initial region including an object region containing the object and a background region containing the background;
a setting unit configured to set a target region including the initial region in the image, and a local region containing a pixel of interest and included in the target region;
a calculating unit configured to calculate local object reliability indicating a degree that the pixel of interest seems to belong to the object region and local background reliability indicating a degree that the pixel of interest seems to belong to the background region by using information of a luminance or color of a local object region and information of a luminance or color of a local background region, respectively, the local object region including the object region and the local region and the local background region including the background region and the local region;
a deciding unit configured to decide that the pixel of interest belongs to one of the object region and the background region, based on the local object reliability and the local background reliability; and
an outputting unit configured to output region information representing the one of the object region and the background region which is decided by the deciding unit.

15. The apparatus according to claim 14, wherein the setting unit sets the target region including all pixels in the image.

16. The apparatus according to claim 14, wherein the setting unit comprises
a calculating unit configured to calculate a plurality of positions of boundary pixels between the object region and the background region, and
a setting unit configured to set in the image a region containing the boundary pixels and having a width corresponding to number of pixels as the target region.

17. The apparatus according to claim 14, wherein the setting unit sets a graphic pattern with reference to the pixel of interest, and sets an interior of the graphic pattern as the local region.

18. The apparatus according to claim 14, wherein
the calculating unit uses an area of an interior of the local object region having the same luminance or color as that of the pixel of interest as the local object reliability, and an area of an interior of the local background region having a same luminance or color as that of the pixel of interest as the local background reliability, and
the deciding unit decides that the pixel of interest belongs to a region with higher reliability of the local object reliability and the local background reliability.

19. The apparatus according to claim 14, further comprising:
an obtaining unit configured to obtain a label image having a same size as that of the acquired image, and obtain a plurality of label images; and
a calculating unit configured to calculate a weight value, for each of label values of the label images and each value of a luminance or color of each pixel, by using the acquired image, the initial region, and the label image with respect to the object region and the background region, to acquire a plurality of weight values, and
wherein the estimating unit acquires the weight value for each pixel in the interior of the local object region from three values including a mask value, a label value, and a luminance or color of the pixel in the object region, and uses a sum total of the weight values as the local object reliability and the local background reliability, and
the deciding unit decides that the pixel of interest belongs to a region with higher reliability of the local object reliability and the local background reliability.

20. An image processing apparatus comprising:
an acquiring unit configured to acquire a first image and a second image having a same size as that of the first image;
a generating unit configured to generate an initial region in which each of the first image and the second image is determined as an object region when a difference value between the first image and the second image falls outside a range, and is determined as a background region when the difference value falls within the range; and
an inputting unit configured to input the first image and the initial region and applying, to the first image and the initial region, an image processing apparatus defined in claims 14.

21. An image processing apparatus comprising:
an acquiring unit configured to acquire an image;
an obtaining unit configured to obtain a label image having a same size as that of the acquired image;
a setting unit configured to set a target region in the acquired image and a local region containing a pixel of interest and included in the target region;
a calculating unit configured to calculate, for each local label value, reliability indicating a degree that a pixel of interest seems to belong to a label value by using information of a luminance or color of a local label value region, the local label value region having the label value and included in the local region;
a deciding unit configured to decide, based on the reliability for each local label value, a label value to which the pixel of interest belongs; and
an outputting unit configured to output a label image obtained by the deciding unit.

22. The apparatus according to claim 21, wherein the setting unit sets the target region including all pixels in the acquired image.

23. The apparatus according to claim 21, wherein the setting unit comprises
a calculating unit configured to calculate a plurality of positions of boundary pixels each having a label value different from an adjacent label value in the label image, and
a setting unit configured to set in the image a region containing the boundary pixels and having a width corresponding to number of pixels as the target region.

24. The apparatus according to claim 21, wherein the setting unit sets a graphic pattern with reference to the pixel of interest, and sets an interior of the graphic pattern as the local region.

25. The apparatus according to claim 21, wherein
the setting unit uses an area of an interior of the local label value region having a same luminance or color as that of the pixel of interest as the reliability for each local label value, and
the deciding unit decides that the pixel of interest belongs to a region with a label value having highest reliability of reliability items each decided for each local label value.

26. The apparatus according to claim 25, wherein the setting unit comprises:
an initializing unit configured to initialize a hash table holding hash elements as pairs of label values and occurrence frequencies, each of the hash elements failing to exist in the hash table;
a calculating unit configured to calculate a hash element position at which the label value is held in the hash table;
an increasing unit configured to increase an occurrence-frequency value of the label value if the label value is held at the hash element position;
a creating unit configured to create a hash element on which the label value and the occurrence-frequency value are recorded in the hash table if the label value fails to be held at the hash element position, and
an applying unit configured to apply the increasing unit and the creating unit to all pixels in the local region with respect to the pixel of interest, and to calculate the area.

27. An image processing program stored in a computer readable medium comprising:
means for instructing a computer to acquire an image including an object and a background and an initial region including an object region containing the object and a background region containing the background;
means for instructing a computer to set a target region including the initial region in the image, and a local region containing a pixel of interest and included in the target region;
means for instructing a computer to calculate local object reliability indicating a degree that the pixel of interest seems to belong to the object region and local background reliability indicating a degree that the pixel of interest seems to belong to the background region by using information of a luminance or color of a local object region and information of a luminance or color of a local background region, respectively, the local object region including the object region and the local region and the local background region including the background region and the local region;
means for instructing a computer to decide that the pixel of interest belongs to one of the object region and the background region, based on the local object reliability and the local background reliability; and
means for instructing a computer to output region information representing the one of the object region and the background region which is decided by the deciding means.

28. An image processing program stored in a computer readable medium comprising:
means for instructing a computer to acquire an image;
means for instructing a computer to obtain a label image having a same size as that of the acquired image;
means for instructing a computer to set a target region in the acquired image and a local region containing a pixel of interest and included in the target region;
means for instructing a computer to calculate, for each local label value, reliability indicating a degree that a pixel of interest seems to belong to a label value by using information of a luminance or color of a local label value region, the local label value region having the label value and included in the local region;
means for instructing a computer to decide, based on the reliability for each local label value, a label value to which the pixel of interest belongs; and
means for instructing a computer to output a label image obtained by the deciding means.
